(19) United States
(12) Patent Application Publication
(10) Pub. No.: US 2025/0263901 A1
(43) Pub. Date: Aug. 21, 2025

(54) CONTROL SYSTEM AND CONTROL METHOD FOR LOADING MACHINE

(71) Applicant: Komatsu Ltd., Tokyo (JP)

(72) Inventors: Kazuhiro HATAKE, Tokyo (JP); Yusuke SAIGO, Tokyo (JP)

(21) Appl. No.: 18/289,757

(22) PCT Filed: May 19, 2022
(86) PCT No.: PCT/JP2022/020767

§ 371 Date: May 14, 2024

(30) Foreign Application Priority Data
May 19, 2021 (JP) 2021-084780

(51) Int. Cl. E02F 3/43; E02F 9/20; E02F 9/26

(52) U.S. Cl. CPC E02F 3/437; E02F 9/2033; E02F 9/262; E02F 9/265

(57) ABSTRACT

An operation signal input unit receives an input of a manual operation signal for a swing body and work equipment on the basis of an operation of an operation device. A movement control unit generates an automatic operation signal for driving the swing body and the work equipment. An output determination unit determines to output the manual operation signal for any of the swing body and the work equipment for which there has been an input of the manual operation signal and determines to output the automatic operation signal for any thereof for which there has been no input of the manual operation signal on the basis of the input manual operation signal. An operation signal output unit outputs the manual operation signal or the automatic operation signal for each of the swing body and the work equipment on the basis of a result of the determination.

### TECHNICAL FIELD

The present disclosure relates to a control system and a control method for a loading machine.

Priority is claimed on Japanese Patent Application No. 2021-084780 filed on May 19, 2021, the content of which is incorporated herein by reference.

### BACKGROUND ART

Patent Document 1 discloses a technology related to semi-automatic control of a loading machine. The semi-automatic control according to Patent Document 1 is a control performing automatic excavation by a control device receiving an excavation instruction from an operator after completion of loading with respect to a loading target such as a dump truck and controlling swinging of the loading machine and driving of work equipment.

### CITATION LIST

### Patent Document

### Patent Document 1

Japanese Unexamined Patent Application, First Publication No. 2020-041352

### SUMMARY OF INVENTION

### Technical Problem

Incidentally, a position of a bucket after the control by the semi-automatic control and a position of the bucket intended by the operator do not always match.

An object of the present disclosure is to provide a control system and a control method for a loading machine in which the loading machine is controlled according to an operation by an operator during an automatic control of the loading machine.

### Solution to Problem

According to one aspect of the present disclosure, a control system for a loading machine is a control device for a loading machine including a swing body swinging around a swing center, a support part supporting the swing body, and work equipment having a bucket and attached to the swing body, and the control system for a loading machine includes an operation signal input unit configured to receive an input of a manual operation signal for the swing body and the work equipment on the basis of an operation of the operation device, a movement control unit configured to generate an automatic operation signal for driving the swing body and the work equipment, an output determination unit configured to determine to output the manual operation signal for any of the swing body and the work equipment for which there has been an input of the manual operation signal and determine to output the automatic operation signal for any thereof for which there has been no input of the manual operation signal, on the basis of the input manual operation signal, and an operation signal output unit configured to output the manual operation signal or the automatic operation signal for each of the swing body and the work equipment on the basis of a result of the determination.

### Advantageous Effects of Invention

According to the aspect described above, the control system for a loading machine can control the loading machine according to an operation by an operator during an automatic control of the loading machine.

### BRIEF DESCRIPTION OF DRAWINGS

FIG. 1 is a schematic view illustrating a configuration of a loading machine according to a first embodiment.

FIG. 2 is a view illustrating a configuration inside a cab according to the first embodiment.

FIG, 3 is a schematic block diagram showing a configuration of a control device according to the first embodiment.

FIG. 4 is a view illustrating an example of a target posture of work equipment at the start of excavation according to the first embodiment.

FIG. 5 is a view illustrating an example of movement of the loading machine from the start of automatic loading control to the start of dumping according to the first embodiment.

FIG. 6 is a view illustrating an example of movement of the loading machine from the start of dumping to the end of the automatic loading control according to the first embodiment.

FIG. 7 is a view comparing a posture of the work equipment at the start of the automatic loading control and a posture of the work equipment at the end of the automatic loading control in the first embodiment.

FIG. 8 is a flowchart showing an operation of the control device according to the first embodiment.

FIG. 9 is a flowchart showing an operation of the control device from the start of the automatic loading control to the start of dumping according to the first embodiment.

FIG. 10 is a flowchart showing an operation of the control device from the start of dumping to the end of the automatic loading control according to the first embodiment.

FIG. 11 is a flowchart showing an automatic/manual switching determination operation of the control device according to the first embodiment.

FIG. 12 is a diagram showing examples of operation signals for the work equipment according to the first embodiment.

### DESCRIPTION OF EMBODIMENTS

### First Embodiment

Hereinafter, embodiments will be described in detail with reference to the drawings.

### Configuration of Loading Machine 100

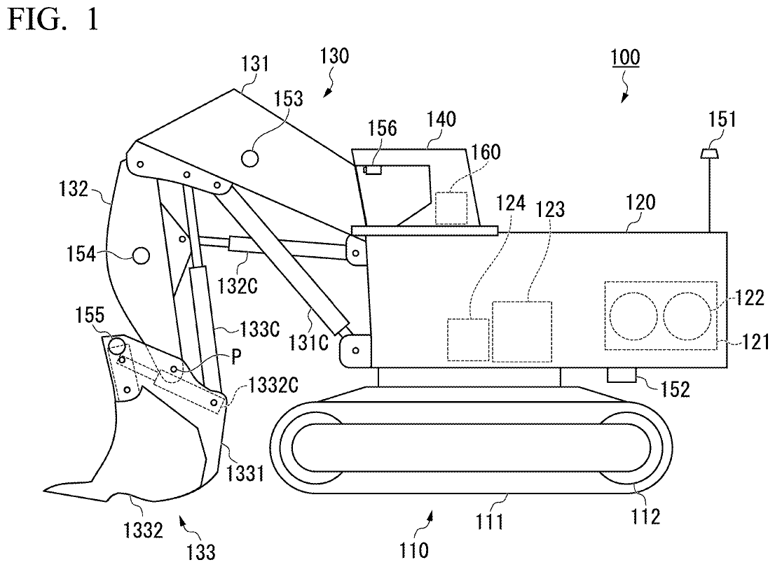

FIG. 1 is a schematic view illustrating a configuration of a loading machine 100 according to a first embodiment.

The loading machine 100 operates at a construction site, excavates a work object such as earth, and loads it onto a loading target T such as a dump truck. The loading machine 100 according to the first embodiment is a face excavator. Further, a loading machine 100 according to another embodiment may be a backhoe excavator or a rope excavator. The loading machine 100 includes an undercarriage 110 (support part), a swing body 120, work equipment 130, and a cab 140.

The undercarriage 110 supports the loading machine 100 to be able to travel. The undercarriage 110 includes two endless tracks 111 provided on the left and right and two traveling motors 112 for driving the endless tracks 111.

The swing body 120 is supported by the undercarriage 110 to be able to swing around a swing center.

The work equipment 130 is driven by a hydraulic pressure. The work equipment 130 is supported by a front portion of the swing body 120 so that it can be driven in a vertical direction. The cab 140 is a space for an operator to be on board and perform an operation of the loading machine 100. The cab 140 is provided in a left front portion of the swing body 120.

Here, a portion of the swing body 120 to which the work equipment 130 is attached is referred to as a front portion. Also, for the swing body 120, with the front portion as a reference, a portion on an opposite side is referred to as a rear portion, a portion on a left side is referred to as a left portion, and a portion on a right side is referred to as a right portion.

### Configuration of Swing Body 120

The swing body 120 includes an engine 121, a hydraulic pump 122, a control valve 123, and a swing motor 124.

The engine 121 is a prime mover that drives the hydraulic pump 122. The engine 121 is an example of a power source.

The hydraulic pump 122 is a variable capacity pump driven by the engine 121. The hydraulic pump 122 supplies a hydraulic oil to actuators (a boom cylinder 131C, an arm cylinder 132C, a bucket cylinder 133C, a clam cylinder 1332C, the travel motors 112, and the swing motor 124) via the control valve 123.

The control valve 123 controls a flow rate of the hydraulic oil supplied from the hydraulic pump 122.

The swing motor 124 is driven by the hydraulic fluid supplied from the hydraulic pump 122 via the control valve 123 to swing the swing body 120.

### Configuration of Work Equipment 130

The work equipment 130 includes a boom 131, an arm 132, a clam bucket 133, the boom cylinder 131C, the arm cylinder 132C, and the bucket cylinder 133C.

A base end portion of the boom 131 is attached to the swing body 120 via a boom pin. Further, in the loading machine 100 illustrated in FIG. 1, the boom 131 is provided at a central portion of a front surface of the swing body 120, but the present disclosure is not limited thereto, and the boom 131 may be attached with an offset in a left-right direction. In this case, a swing center of the swing body 120 is not positioned on a plane of movement of the work equipment 130.

The arm 132 connects the boom 131 and the clam bucket 133. A base end portion of the arm 132 is attached to a distal end portion of the boom 131 via an arm pin.

The clam bucket 133 includes a backhaul 1331 attached to a distal end portion of the arm 132 via a pin, a clamshell 1332 having bucket teeth for excavating earth or the like, and the clam cylinder 1332C for opening and closing the backhaul 1331 and the clamshell 1332. The backhaul 1331 and the clamshell 1332 are connected via a pin to be openable and closable. When the backhaul 1331 and the clamshell 1332 are closed, the backhaul 1331 and clamshell 1332 function as a container for containing excavated earth. On the other hand, when the backhaul 1331 and the clamshell 1332 open, the accommodated earth can be dumped. A base end portion of the clam cylinder 1332C is attached to the backhaul 1331. A distal end portion of the clam cylinder 1332C is attached to the clamshell 1332.

That is, the boom 131, the arm 132, the backhaul 1331, and the clamshell 1332 constitute a linkage. The boom 131, the arm 132, the backhaul 1331, and the clamshell 1332 are each an example of a link part.

The boom cylinder 131C is a hydraulic cylinder for operating the boom 131. A base end portion of the boom cylinder 131C is attached to the swing body 120. A distal end portion of the boom cylinder 131C is attached to the boom 131.

The arm cylinder 132C is a hydraulic cylinder for driving the arm 132. A base end portion of the arm cylinder 132C is attached to the boom 131. A distal end portion of the arm cylinder 132C is attached to the arm 132.

The bucket cylinder 133C is a hydraulic cylinder for driving the clam bucket 133. A base end portion of the bucket cylinder 133C is attached to the arm 132. A distal end portion of the bucket cylinder 133C is attached to a link member connected to the backhaul 1331.

### Configuration of Cab 140

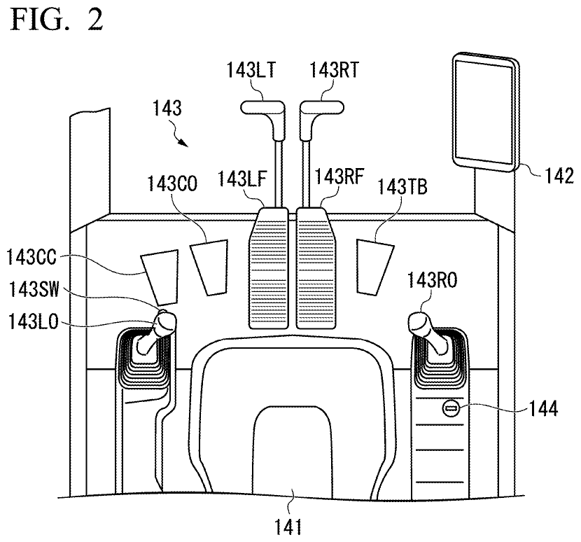

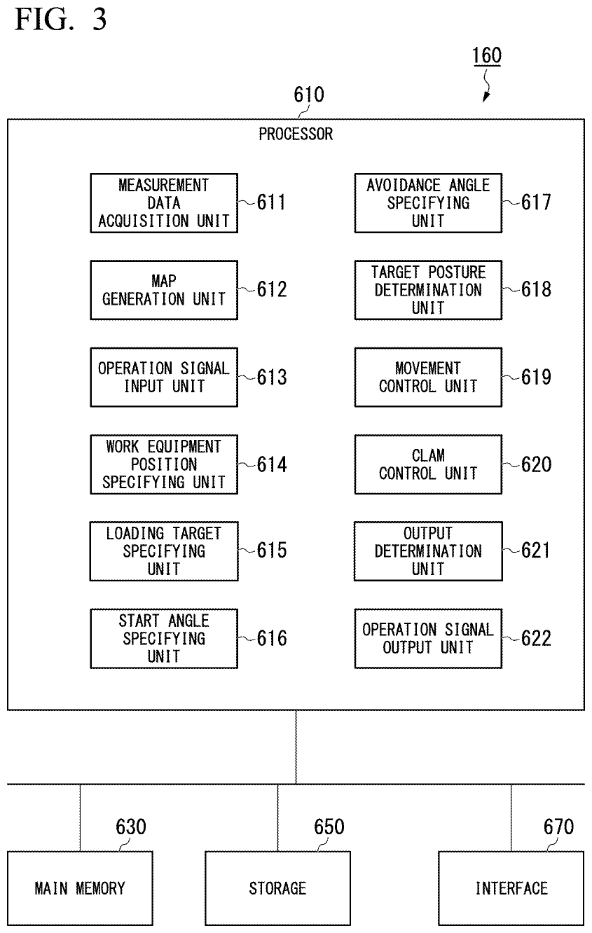

FIG. 2 is a view illustrating a configuration inside the cab 140 according to the first embodiment.

A driver's seat 141, an operation terminal 142, and an operation device 143 are provided in the cab 140. The operation terminal 142 is provided in the vicinity of the driver's seat 141 and serves as a user interface with a control device 160 to be described later. The operation terminal 142 may receive an operation from the operator by, for example, a touch panel. Also, the operation terminal 142 may include a display unit such as an LCD. The touch panel is an example of a display unit.

The operation device 143 is a device for driving the undercarriage 110, the swing body 120, and the work equipment 130 by a manual operation of the operator. The operation device 143 includes a left operation lever 143LO, a right operation lever 143RO, a left foot pedal 143LF, a right foot pedal 143RF, a left travel lever 143LT, a right travel lever 143RT, a clam open pedal 143CO, a clam close pedal 143CC, a swing brake pedal 143TB, and a start switch 143SW.

The left operation lever 143LO is provided on a left side of the driver's seat 141. The right operation lever 143RO is provided on a right side of the driver's seat 141.

The left operation lever 143LO is an operating mechanism for performing a swing operation of the swing body 120 and an excavating/dumping operation of the arm 132. Specifically, when the operator of the loading machine 100 tilts the left operation lever 143LO forward, the arm 132 performs a dumping operation. Also, when the operator of the loading machine 100 tilts the left operation lever 143LO rearward, the arm 132 performs an excavating operation. Also, when the operator of the loading machine 100 tilts the left operation lever 143LO in a right direction, the swing body 120 swings rightward. Also, when the operator of the loading machine 100 tilts the left operation lever 143LO in a left direction, the swing body 120 swings leftward. Further, in another embodiment, the swing body 120 may swing rightward or leftward when the left operation lever 143LO is tilted in a front-rear direction, and the arm 132 may perform an excavating operation or a dumping operation when the left operation lever 143LO is tilted in the left-right direction.

The right operation lever 143RO is an operation mechanism for performing an excavating/dumping operation of the clam bucket 133 and raising/lowering operations of the boom 131. Specifically, when the operator of the loading machine 100 tilts the right operation lever 143RO forward, a lowering operation of the boom 131 is executed. Also, when the operator of the loading machine 100 tilts the right operation lever 143RO rearward, a raising operation of the boom 131 is executed. Also, when the operator of the loading machine 100 tilts the right operation lever 143RO in a right direction, a dumping operation of the clam bucket 133 is performed. Also, when the operator of the loading machine 100 tilts the right operation lever 143RO in a left direction, an excavating operation of the clam bucket 133 is performed. Further, in another embodiment, when the right operation lever 143RO is tilted in the front-rear direction, the clam bucket 133 may perform a dumping operation or an excavating operation, and when the right operation lever 143RO is tilted in the left-right direction, the boom 131 may perform a raising operation or a lowering operation.

The left foot pedal 143LF is disposed on a left side of a floor in front of the driver's seat 141. The right foot pedal 143RF is disposed on a right side of the floor in front of the driver's seat 141. The left travel lever 143LT is pivotally supported by the left foot pedal 143LF, and is configured so that an inclination of the left travel lever 143LT and a depression of the left foot pedal 143LF are interlocked. The right travel lever 143RT is pivotally supported by the right foot pedal 143RF, and is configured so that an inclination of the right travel lever 143RT and a depression of the right foot pedal 143RF are interlocked.

The left foot pedal 143LF and the left travel lever 143LT correspond to a rotational drive of a left crawler track of the undercarriage 110. Specifically, when the operator of the loading machine 100 tilts the left foot pedal 143LF or the left travel lever 143LT forward, the left crawler track rotates in a forward direction. Also, when the operator of the loading machine 100 tilts the left foot pedal 143LF or the left travel lever 143LT rearward, the left crawler track rotates in a rearward direction.

The right foot pedal 143RF and the right travel lever 143RT correspond to a rotational drive of a right crawler track of the undercarriage 110. Specifically, when the operator of the loading machine 100 tilts the right foot pedal 143RF or the right travel lever 143RT forward, the right crawler track rotates in a forward direction. Also, when the operator of the loading machine 100 tilts the right foot pedal 143RF or the right travel lever 143RT rearward, the right crawler track rotates in a rearward direction.

The clam open pedal 143CO and the clam close pedal 143CC are disposed on a right side of the left foot pedal 143LF. The clam open pedal 143CO is disposed adjacent to the left of the clam close pedal 143CC. When the clam open pedal 143CO is depressed, the clam bucket 133 opens at a speed in accordance with a depression amount of the clam open pedal 143CO. When the clam close pedal 143CC is depressed, the clam bucket 133 closes at a speed in accordance with a depression amount of the clam close pedal 143CC.

The swing brake pedal 143TB is disposed on a right side of the right foot pedal 143RF. When the swing brake pedal 143TB is depressed, a relief pressure of a hydraulic circuit connecting the control valve 123 and the swing motor 124 is increased.

Specifically, when the swing brake pedal 143TB is depressed, a solenoid of a variable relief valve provided in the hydraulic circuit connecting the control valve 123 and the swing motor 124 is excited, and thereby the relief pressure of the variable relief valve is increased. Thereby, a braking force related to the swing can be increased.

The start switch 143SW is provided on, for example, a handle portion of the left operation lever 143LO. Further, the start switch 143SW may be disposed to be positioned in the vicinity of the operator seated on the driver's seat 141. When the start switch 143SW is depressed, an automatic loading instruction signal is output to the control device 160. The control device 160 starts an automatic loading control to be described later when it receives an input of the automatic loading instruction signal.

### Configuration of Measurement System

As illustrated in FIG. 1, the loading machine 100 includes a position/azimuth direction calculator 151, an inclination measuring device 152, a boom angle sensor 153, an arm angle sensor 154, a bucket angle sensor 155, and a detection device 156.

The position/azimuth direction calculator 151 calculates a position of the swing body 120 and an azimuth direction in which the swing body 120 is directed. The position/azimuth direction calculator 151 includes two receivers that receive positioning signals from artificial satellites that form a global navigation satellite system (GNSS). The two receivers are installed at different positions on the swing body 120. The position/azimuth direction calculator 151 detects a position of a representative point (origin of an excavator coordinate system) of the swing body 120 in a field coordinate system on the basis of the positioning signals received by the receivers.

The position/azimuth direction calculator 151 uses the positioning signals received by the two receivers to calculate the azimuth direction in which the swing body 120 is directed as a relationship of an installation position of one receiver with respect to an installation position of the other receiver. The azimuth direction in which the swing body 120 is directed is a direction orthogonal to the front surface of the swing body 120 and is equal to a horizontal component of an extension direction of a straight line extending from the boom 131 to the clam bucket 133 of the work equipment 130.

The inclination measuring device 152 measures an acceleration and an angular velocity of the swing body 120 and detects a posture (for example, a roll angle, a pitch angle, and a yaw angle) of the swing body 120 on the basis of the measurement result. The inclination measuring device 152 is installed on, for example, a lower surface of the swing body 120. The inclination measuring device 152 can use, for example, an inertial measurement unit (IMU).

The boom angle sensor 153 is attached to the boom 131 and detects an inclination angle of the boom 131.

The arm angle sensor 154 is attached to the arm 132 and detects an inclination angle of the arm 132.

The bucket angle sensor 155 is attached to the backhaul 1331 of the clam bucket 133 and detects an inclination angle of the clam bucket 133.

The boom angle sensor 153, the arm angle sensor 154, and the bucket angle sensor 155 according to the first embodiment detect inclination angles with respect to a horizontal plane. Further, angle sensors according to another embodiment are not limited thereto, and may detect inclination angles with respect to another reference plane. For example, in another embodiment, the angle sensors may detect relative rotation angles by a potentiometer provided at base end portions of the boom 131, the arm 132, and the clam bucket 133, or may detect inclination angles by measuring cylinder lengths of the boom cylinder 131C, the arm cylinder 132C, and the bucket cylinder 133C and converting the cylinder lengths into angles.

The detection device 156 detects a three-dimensional position of an object present around the loading machine 100. A stereo camera, a laser scanner, an ultra wide band (UWB) ranging device, and the like can be mentioned as examples of the detection device 156. The detection device 156 is provided in, for example, an upper portion of the cab 140 so that a detection direction is directed forward. Further, the detection device 156 may be provided at any position as long as surroundings of the loading machine 100 can be imaged. For example, the detection device 156 may be provided on a side wall or the like of the swing body 120 outside the cab 140. Also, the detection direction may not be directed forward. The detection device 156 specifies a three-dimensional position of an object in a coordinate system with a position of the detection device 156 as a reference. Further, the loading machine 100 according to another embodiment may include a plurality of detection devices 156.

### Configuration of Control Device 160

FIG. 3 is a schematic block diagram showing a configuration of the control device 160 according to the first embodiment.

The loading machine 100 includes the control device 160. The control device 160 may be mounted on the operation terminal 142, or may be provided separately from the operation terminal 142 and receive input/output from the operation terminal 142. The control device 160 receives an operation signal from the operation device 143. The operation signal indicates an object to be operated and a drive speed. Hereinafter, a magnitude of the drive speed indicated by the operation signal is also referred to as an operation amount. The control device 160 drives the work equipment 130, the swing body 120, and the undercarriage 110 by outputting a received operation signal or an operation signal for the automatic loading control generated by calculation to the control valve 123. Hereinafter, the operation signal received from the operation device 143 is also called a manual operation signal, and the operation signal generated by calculation is also called an automatic operation signal.

The control device 160 is a computer including a processor 610, main memory 630, a storage 650, and an interface 670. The storage 650 stores a program. The processor 610 reads the program from the storage 650, decompresses it in the main memory 630, and executes processing according to the program.

As examples of the storage 650, a semiconductor memory, a magnetic disk, a magneto-optical disk, an optical disk, and the like can be mentioned. The storage 650 may be internal media directly connected to a common communication line of the control device 160 or external media connected to the control device 160 via the interface 670. The main memory 630 and the storage 650 are non-transitory tangible storage media.

The processor 610 includes, by executing a program, a measurement data acquisition unit 611, a map generation unit 612, an operation signal input unit 613, a work equipment position specifying unit 614, a loading target specifying unit 615, a start angle specifying unit 616, an avoidance angle specifying unit 617, a target posture determination unit 618, a movement control unit 619, a clam control unit 620, an output determination unit 621, and an operation signal output unit 622.

The measurement data acquisition unit 611 acquires measurement data from the measurement system of the loading machine 100. Specifically, the measurement data acquisition unit 611 acquires measurement data from the position/azimuth direction calculator 151, the inclination measuring device 152, the boom angle sensor 153, the arm angle sensor 154, the bucket angle sensor 155, and the detection device 156. The measurement data acquisition unit 611 calculates an angle of the swing body 120 by integrating an angular velocity of the swing body 120 measured by the inclination measuring device 152.

The map generation unit 612 generates map data showing surroundings of the loading machine 100 using the measurement data acquired from the detection device 156. The map generation unit 612 generates the map data by, for example, a simultaneous localization and mapping (SLAM) technology. The map data is expressed by a vehicle body coordinate system. The vehicle body coordinate system is an orthogonal coordinate system expressed by an axis extending in the front-rear direction, an axis extending in the left-right direction, and an axis extending in the vertical direction with the swing center of the swing body 120 as an origin. Since the detection device 156 is fixed to the swing body 120, the map generation unit 612 can generate map data in the vehicle body coordinate system by translating calculation results of the SLAM on the basis of a positional relationship between the swing center and the detection device 156. The map data generated by the map generation unit 612 is recorded in the main memory

The operation signal input unit 613 receives an input of the manual operation signal from the operation device 143. The manual operation signal includes a rotation operation signal for the boom 131, a rotation operation signal for the arm 132, a rotation operation signal for the clam bucket 133, an open/close operation signal for the clam bucket 133, a swing operation signal for the swing body 120, a travel operation signal for the undercarriage 110, and an automatic loading instruction signal for the loading machine 100.

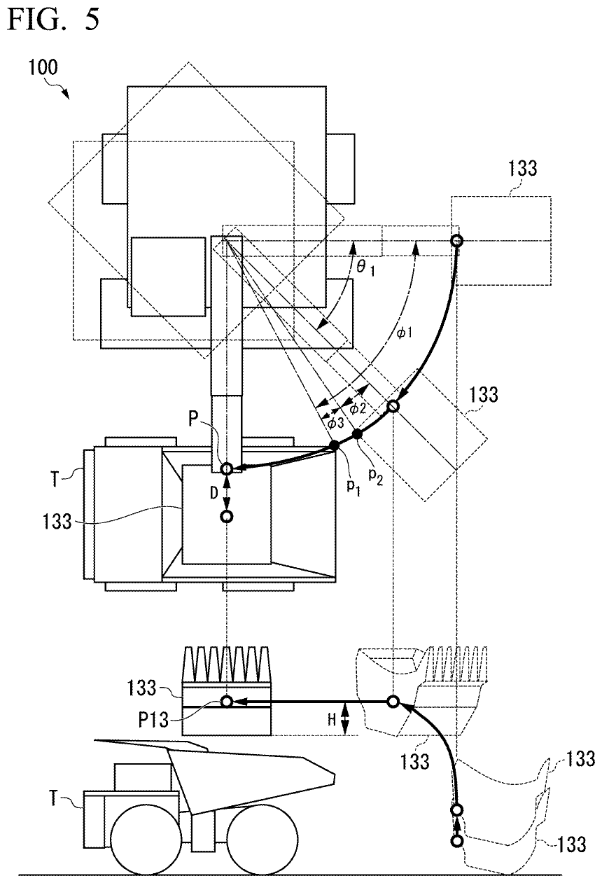

The work equipment position specifying unit 614 specifies a position P (FIG. 5) of a distal end of the arm 132 in the vehicle body coordinate system with the swing body 120 as a reference and a height H (FIG. 5) from the distal end of the arm 132 to a lowest point of the clam bucket 133 on the basis of the measurement data acquired by the measurement data acquisition unit 611. The lowest point of the clam bucket 133 refers to a point of an outer shape of the clam bucket 133 in which a distance from the ground level is the smallest.

The work equipment position specifying unit 614 obtains a vertical direction component and a horizontal direction component of the length of the boom 131 on the basis of the inclination angle of the boom 131 and a known length (a distance from the pin at the base end portion to the pin at the distal end portion) of the boom 131. Similarly, the work equipment position specifying unit 614 obtains a vertical direction component and a horizontal direction component of the length of the arm 132. The work equipment position specifying unit 614 specifies, as the position P of the distal end of the arm 132, a position away from the position of the loading machine 100 in a direction specified by the azimuth direction and the posture of the loading machine 100, by a sum of the vertical direction components and a sum of the horizontal direction components of the lengths of the boom 131 and the arm 132. Also, on the basis of the inclination angle of the clam bucket 133 and a known shape of the clam bucket 133, the work equipment position specifying unit 614 specifies the lowest point in the vertical direction of the clam bucket 133, and specifies the height H from the distal end of the arm 132 to the lowest point and a horizontal distance D (FIG. 5) from the distal end of the arm 132 to the lowest point.

When the automatic loading instruction signal is input to the operation signal input unit 613, the loading target specifying unit 615 determines a loading point on the basis of the map data generated by the map generation unit 612. The loading point refers to a position above the loading target T (for example, a dump body of the dump truck). In the automatic loading control, a dump control is started when the distal end of the arm 132 reaches the loading point. Specifically, the loading target specifying unit 615 specifies a position and shape of the loading target T from the map data and a known shape of the loading target T. For example, the loading target specifying unit 615 specifies a position of the loading target T by three-dimensional pattern matching. The loading target specifying unit 615 determines the loading point on the basis of a center point of an upper surface of the specified loading target T and the shape of the clam bucket 133.

The start angle specifying unit 616 specifies, as a start angle, an angle between the azimuth direction in which the swing body 120 is directed when the automatic loading instruction signal is input to the operation signal input unit 613 and the azimuth direction in which the loading point is present. The azimuth direction in which the swing body 120 is directed when the automatic loading instruction signal is input can also be said to be an azimuth direction in which the swing body 120 is directed when the automatic loading control of the loading machine 100 is started. That is, the start angle specifying unit 616 specifies, as the start angle, an angle formed by a line segment extending from the swing center of the swing body 120 to the position of the distal end of the arm 132 specified by the work equipment position specifying unit 614 and a line segment extending from the swing center of the swing body 120 to the loading point when the automatic loading control is started.

The avoidance angle specifying unit 617 specifies an interference avoidance angle on the basis of the position and shape of the loading target T specified by the loading target specifying unit 615. The interference avoidance angle refers to a swing angle when the work equipment 130 and the loading target T do not interfere with each other in a plan view from above. Specifically, the avoidance angle specifying unit 617 specifies the interference avoidance angle by the following procedures.

The avoidance angle specifying unit 617 specifies a rearmost point p1 (FIG. 5) of the outer shape of the loading target T in a swing direction of the swing body 120 on the basis of the position and shape of the loading target T specified by the loading target specifying unit 615. The avoidance angle specifying unit 617 obtains a first angle ϕ1 (FIG. 5) formed by a line segment extending from the swing center of the swing body 120 to the position of the distal end of the arm 132 and a line segment extending from the swing center of the swing body 120 to the specified point of the outer shape of the loading target T when the automatic loading control is started. The avoidance angle specifying unit 617 specifies a foremost point p2 (FIG. 5) of the outer shape of the clam bucket 133 in the swing direction of the swing body 120 on the basis of the position of the distal end of the arm 132 specified by the work equipment position specifying unit 614 and the known shape of the clam bucket 133. The avoidance angle specifying unit 617 obtains a second angle ϕ2 formed by the line segment extending from the swing center of the swing body 120 to the position of the distal end of the arm 132 and a line segment extending from the swing center of the swing body 120 to the specified point of the outer shape of the clam bucket 133. The avoidance angle specifying unit 617 obtains an interference avoidance angle ϕ1 (FIG. 5) by further subtracting a control margin angle ϕ3 from a difference between the first angle ϕ1 and the second angle ϕ2.

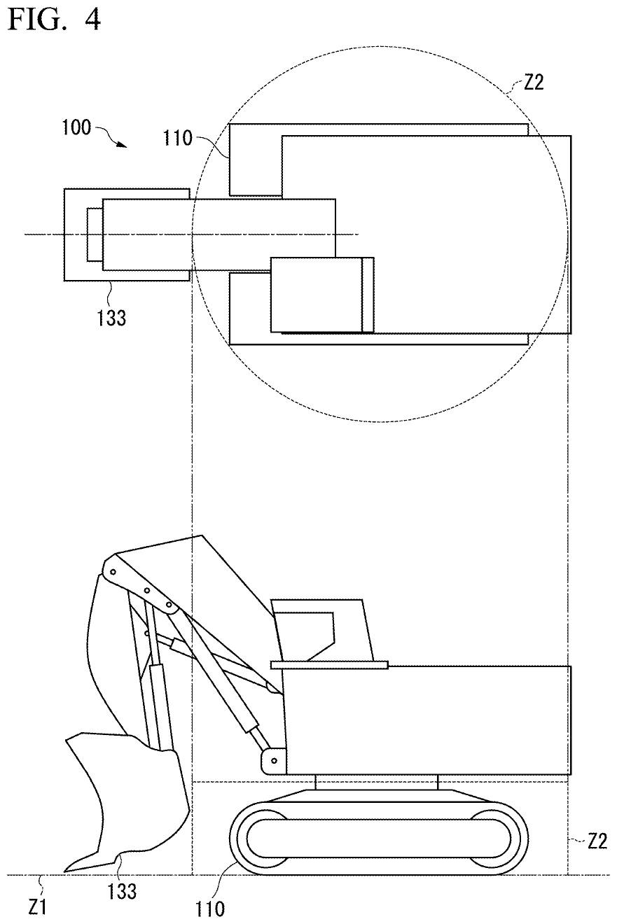

The target posture determination unit 618 calculates a posture of the work equipment 130 when the distal end of the arm 132 is positioned at the loading point on the basis of a distance and a height from the swing center to the loading point determined by the loading target specifying unit 615, and determines a target posture when the work equipment 130 starts to dump. Also, the target posture determination unit 618 determines a target posture of the work equipment 130 at the start of excavation by reading a predetermined target posture of the work equipment 130 at the start of excavation from the storage 650 or the main memory 630. FIG. 4 is a view illustrating an example of the target posture of the work equipment 130 at the start of excavation according to the first embodiment. The target posture at the start of excavation is a posture such that, for example, the clam bucket 133 approaches the undercarriage 110 to the extent that it does not interfere with the undercarriage 110, and a bottom surface of the clam bucket 133 approaches a plane Z1 including a bottom surface of the undercarriage 110 to the extent that it does not come into contact with the plane Z1. That is, the clam bucket 133 in the target posture at the start of excavation is positioned on an outward side from an interference prohibition region Z2 formed outside a virtual circular cylinder circumscribing the undercarriage 110 in terms of a distance from the swing center. Such a target posture is a posture that facilitates proceeding to subsequent excavation work. Further, the interference prohibition region Z2 is defined by a virtual circular cylinder instead of a rectangular parallelepiped corresponding to the undercarriage 110, and thereby a contact between the undercarriage 110 and the clam bucket 133 can be prevented when the swing body 120 swings. The bottom surface of the clam bucket 133 in the target posture at the start of excavation may be parallel to the plane Z1 or may form an acute angle with the plane Z1. The target posture is represented by, for example, positions of the distal end of the boom 131, the distal end of the arm 132, and the bucket teeth of the clam bucket 133 in the vehicle body coordinate system. Further, the posture of the work equipment 130 includes positions and angles of parts constituting the work equipment 130 in the vehicle body coordinate system.

When the operation signal input unit 613 has received an input of the automatic loading instruction signal, the movement control unit 619 shown in FIG. 3 generates the automatic operation signal that realizes a combined movement of the swing body 120 and the work equipment 130 for moving the clam bucket 133 to the loading point on the basis of the loading point specified by the loading target specifying unit 615 and the interference avoidance angle specified by the avoidance angle specifying unit 617. Specifically, the movement control unit 619 generates the automatic operation signal for driving the work equipment 130 so that the posture of the work equipment 130 reaches the target posture at the start of dumping determined by the target posture determination unit 618. Also, the movement control unit 619 adjusts a swing start timing so that the posture of the work equipment 130 reaches the target posture at the start of dumping before the swing angle reaches the interference avoidance angle. That is, when the swing body 120 has started swinging, and if the work equipment 130 does not have the target posture before the swing angle due to the swing reaches the interference avoidance angle, the movement control unit 619 does not generate the swing operation signal for the swing body 120, and only generates an operation signal for the work equipment 130. On the other hand, if the work equipment 130 is determined to have the target posture before the swing angle due to the swing reaches the interference avoidance angle, the movement control unit 619 generates the swing operation signal for the swing body 120 and the operation signal for the work equipment 130, and realizes the combined movement of the swing body 120 and the work equipment 130.

Also, after the distal end of the arm 132 has reached the loading point, the movement control unit 619 generates the automatic operation signal for driving the swing body 120 and the work equipment 130 so that the swing body 120 swings to the start angle specified by the start angle specifying unit 616 and the posture of the work equipment 130 reaches the target posture at the start of excavation determined by the target posture determination unit 618.

The clam control unit 620 generates the automatic operation signal for opening the clam bucket 133 when the distal end of the arm 132 reaches the loading point. Also, the clam control unit 620 generates the automatic operation signal for closing the clam bucket 133 when the swing angle of the swing body 120 exceeds a difference between the start angle and the interference avoidance angle. Further, even before the distal end of the arm 132 reaches the loading point, the clam control unit 620 may generate the automatic operation signal for opening the clam bucket 133 when the clam bucket 133 and the loading target T overlap in a plan view from above.

The output determination unit 621 determines whether the swing body 120, the boom 131, the arm 132, the clam bucket 133, and the clamshell 1332 (controlled objects) are each to be controlled by the manual operation signal or the automatic operation signal on the basis of the manual operation signal that has been input to the operation signal input unit 613 and the automatic operation signal generated by the movement control unit 619. The output determination unit 621 records and manages a value of an automatic operation flag in the main memory 630 for each controlled object. The output determination unit 621 determines that a controlled object whose automatic operation flag is ON is controlled by the automatic operation signal, and a controlled object whose automatic operation flag is OFF is controlled by the manual operation signal.

The operation signal output unit 622 outputs the manual operation signal that has been input to the operation signal input unit 613 or the automatic operation signal generated by the movement control unit 619 on the basis of the determination result of the output determination unit 621.

### Operation During Automatic Loading Control

Here, movement of the loading machine 100 during the automatic loading control according to the first embodiment will be described with reference to the drawings.

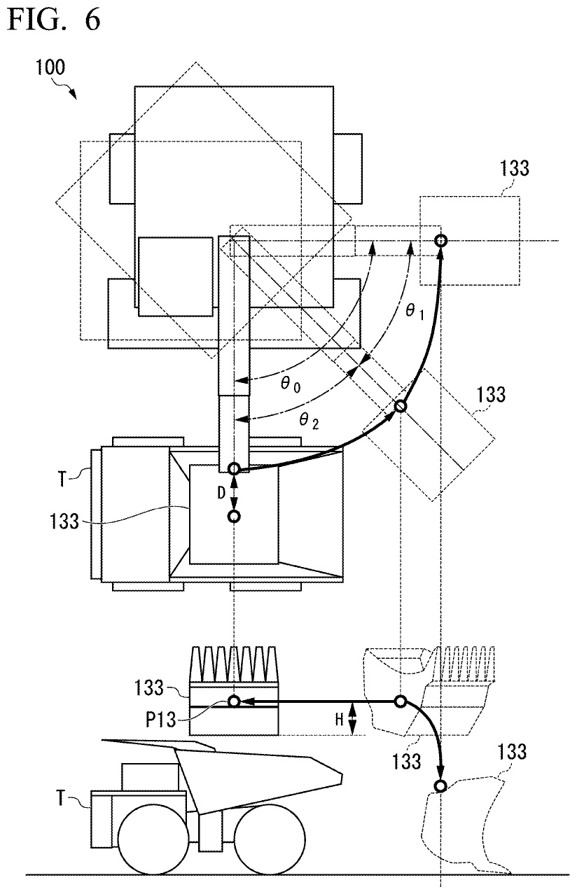

FIG. 5 is a view illustrating an example of movement of the loading machine 100 from the start of the automatic loading control to the start of dumping according to the first embodiment. FIG. 6 is a view illustrating an example of movement of the loading machine 100 from the start of dumping to the end of the automatic loading control according to the first embodiment.

The automatic loading control according to the first embodiment is started when the start switch 143SW is depressed in a state in which the work equipment 130 has excavated earth, which is an object to be excavated, by a manual operation by the operator and the earth is held in the clam bucket 133. When the automatic loading control is started, the loading machine 100 dumps the earth above the loading target T, and moves the work equipment 130 to a subsequent excavation start point. In the first embodiment, at the end of the automatic loading control, the swing body 120 is directed in a direction in which the automatic loading control has been started to facilitate subsequent excavation processing. Also, in order to facilitate the subsequent excavation processing, the work equipment 130 is placed in a posture in which the bottom surface of the clam bucket 133 is lowered close to the ground and the clam bucket 133 is brought closer to a vehicle body side.

Specifically, when the automatic loading control is started, the control device 160 first starts driving of the work equipment 130 (the boom 131, the arm 132, and the clam bucket 133) and moves the clam bucket 133 upward as illustrated in FIG. 5. After a delay, the control device 160 causes the swing body 120 to start swinging. The control device 160 adjusts a swing start timing so that the posture of the work equipment 130 reaches the target posture at the start of dumping before the swing angle of the swing body 120 becomes the same as the interference avoidance angle θ₁. Hereinafter, the interference avoidance angle θ₁ is also referred to as a first interference avoidance angle θ₁. Further, if the posture of the work equipment 130 reaches the target posture at the start of dumping before the swing angle of the swing body 120 becomes the same as the first interference avoidance angle θ₁, that is, when a height of the lowest point of the clam bucket 133 is higher than the upper surface of the loading target T, the work equipment 130 does not come into contact with the loading target T due to the swing of the swing body 120. Thereafter, when the distal end of the arm 132 reaches the loading point, the control device 160 opens the clam bucket 133 and starts dumping.

After a certain period of time has elapsed since the start of dumping, the control device 160 causes the swing body 120 to start swinging as illustrated in FIG. 6. The control device 160 does not start driving of the work equipment 130 until the swing angle of the swing body 120 exceeds an angle θ₂ which is a difference between a start angle θ₀ and the interference avoidance angle θ₁. Hereinafter, the angle θ₂ is also referred to as a second interference avoidance angle θ₂. When the swing angle of the swing body 120 exceeds the second interference avoidance angle θ₂, the control device 160 starts driving of the work equipment 130. When the swing angle of the swing body 120 reaches the start angle θ₀, the control device 160 ends driving of the swing body 120. Also, when the posture of the work equipment 130 reaches the target posture at the start of excavation, the control device 160 ends driving of the work equipment 130.

Further, after the swing angle of the swing body 120 has exceeded the second interference avoidance angle θ₂, the control device 160 receives an operation of the operator from the operation device 143. For a controlled object that has received an operation by the operator, the control device 160 does not output the automatic operation signal, but outputs the manual operation signal. On the other hand, for a controlled object that has not received an operation by the operator, the control device 160 continues to output the automatic operation signal.

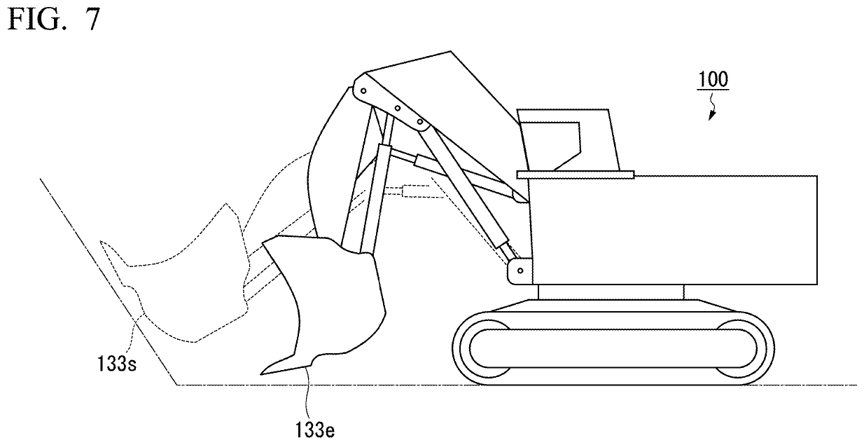

FIG. 7 is a view comparing a posture of the work equipment 130 at the start of the automatic loading control and a posture of the work equipment 130 at the end of the automatic loading control in the first embodiment. The automatic loading control is started in a state in which the work equipment 130 excavates earth and the earth is held in the clam bucket 133. Therefore, a posture 133s of the clam bucket 133 at the start of the automatic loading control is a posture with the bucket teeth facing upward above the object to be excavated. When excavating the object to be excavated, it is necessary to scoop it up from below with the bucket teeth facing the object to be excavated, and therefore, the position and posture of the clam bucket 133 need to be changed from the posture 133s of the clam bucket 133 at the start of the automatic loading control, in order to start the excavation work. On the other hand, a posture 133e of the clam bucket 133 at the end of the automatic loading control, that is, the target posture at the start of excavation, is a posture with the bucket teeth facing forward at a height close to the ground level. Thereby, the operator can easily transfer to the subsequent excavation work by bringing the posture of the clam bucket 133 into the target posture at the start of excavation when the automatic loading control ends.

### Operation of Control Device 160

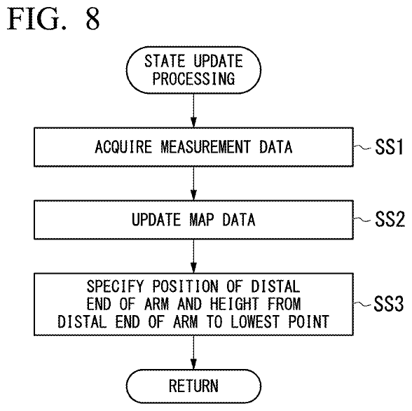

FIG. 8 is a flowchart showing an operation of the control device 160 according to the first embodiment.

The control device 160 of the loading machine 100 performs state update processing shown in FIG. 8 at regular control cycles during operation.

The measurement data acquisition unit 611 acquires measurement data from the position/azimuth direction calculator 151, the inclination measuring device 152, the boom angle sensor 153, the arm angle sensor 154, the bucket angle sensor 155, and the detection device 156 (step SS1). The map generation unit 612 updates the map data recorded in the main memory 630 using the measurement data acquired from the detection device 156 in step SS1 (step SS2). Thereby, the control device 160 can always keep a latest state of the map data representing a situation in the vicinity of the loading machine 100 so that a latest position of the loading target T appears in the map data.

The work equipment position specifying unit 614 specifies the position P of the distal end of the arm 132 in the vehicle body coordinate system with the swing body 120 as a reference and the height H from the distal end of the arm 132 to the lowest point of clam bucket 133 on the basis of the measurement data acquired in step SS1 (step SS3). Thereby, the control device 160 can constantly specify a current posture of the work equipment 130.

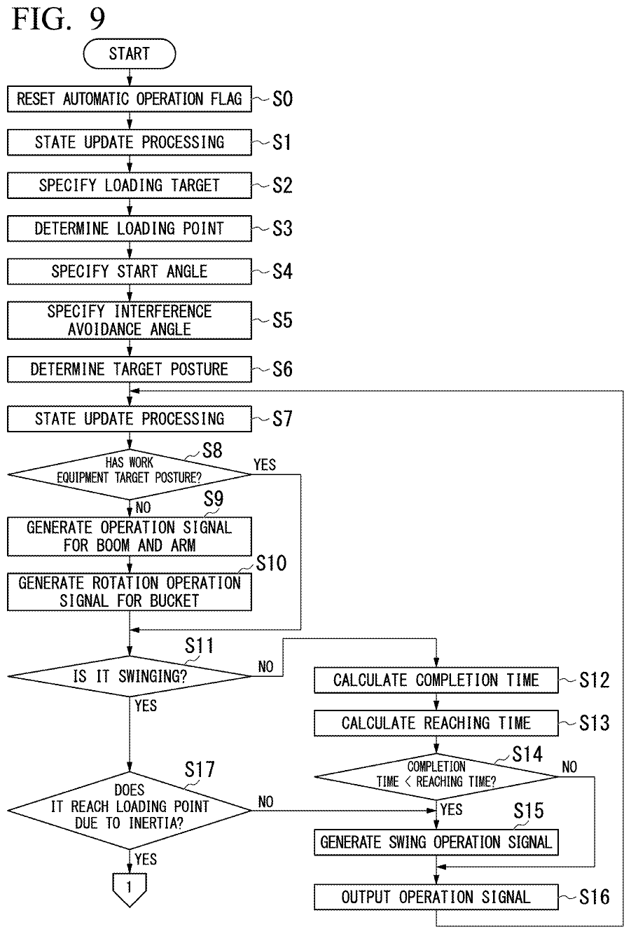

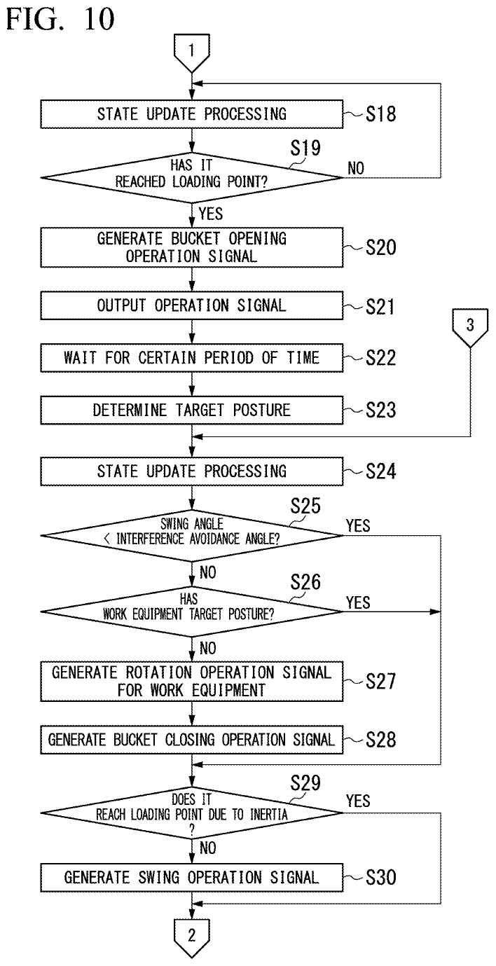

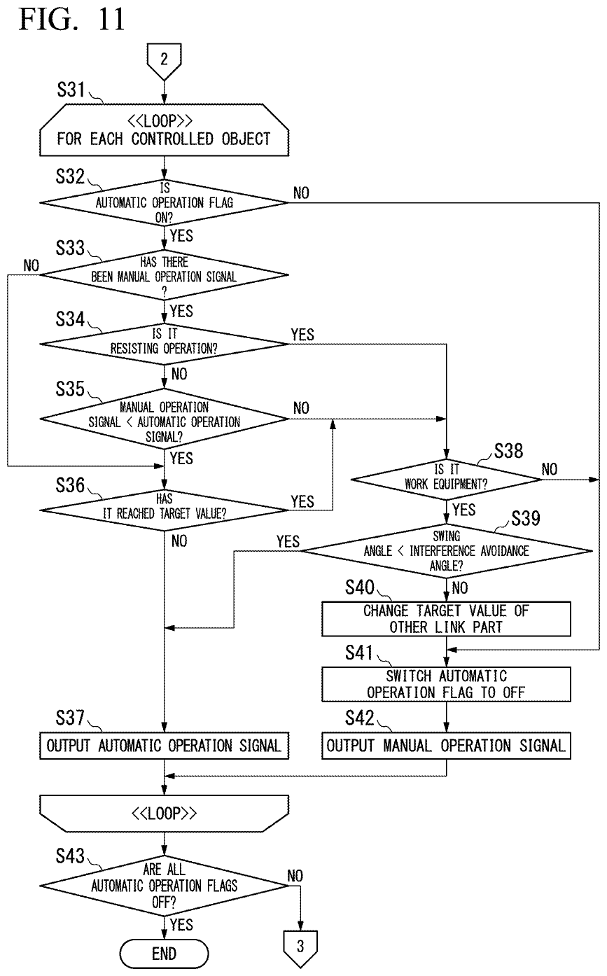

FIG. 9 is a flowchart showing an operation of the control device 160 from the start of the automatic loading control to the start of dumping according to the first embodiment. FIG. 10 is a flowchart showing an operation of the control device 160 from the start of dumping to the end of the automatic loading control according to the first embodiment. FIG. 11 is a flowchart showing an automatic/manual switching determination operation of the control device according to the first embodiment.

When the start switch 143SW is depressed by the operator, the operation signal input unit 613 of the control device 160 receives an input of the automatic loading instruction signal. The control device 160 starts the automatic loading control from step S0 in FIG. 9 with the automatic loading instruction signal as a trigger.

When the automatic loading instruction signal is input, the output determination unit 621 of the control device 160 resets all values of automatic operation flags related to the swing body 120, the boom 131, the arm 132, clam bucket 133, and the clamshell 1332 to ON (step S0). The control device 160 updates the measurement data, the map data, and the posture of the work equipment 130 to a latest state by the state update processing shown in FIG. 8 (step S1). The loading target specifying unit 615 specifies the position and shape of the loading target T on the basis of the map data updated in step S1 (step S2). The loading target specifying unit 615 determines the loading point on the basis of the position of the loading target T specified in step S2 and the height H from the distal end of the arm 132 to the lowest point of the clam bucket 133 specified in step S1 (step S3).

The start angle specifying unit 616 specifies the start angle θ₀ on the basis of the position of the loading point in the map data determined in step S3 (step S4). Since the map data is expressed by the vehicle body coordinate system, the start angle specifying unit 616 specifies, for example, an angle of a position vector of the loading point with respect to a coordinate axis extending forward of the swing body 120 as the start angle θ₀. The avoidance angle specifying unit 617 specifies the first interference avoidance angle θ₁ on the basis of the position and shape of the loading target T specified in step S2 (step S5). The target posture determination unit 618 determines postures of the boom 131 and the arm 132 when the distal end of the arm 132 is positioned at the loading point as the target posture (step S6).

Next, the control device 160 updates the measurement data, the map data, and the posture of the work equipment 130 to the latest state by the state update processing shown in FIG. 8 (step S7). Next, the movement control unit 619 determines whether or not the posture of the work equipment 130 specified in step S7 approximates the target posture determined in step S6 (step S8). For example, when a difference between the position of the distal end of the arm 132 in the target posture and a current position of the distal end of the arm 132 is equal to or less than a predetermined value, the movement control unit 619 determines that the posture of the work equipment 130 approximates the target posture.

If the posture of the work equipment 130 does not approximate the target posture (step S8: NO), the movement control unit 619 generates the automatic operation signal for bringing the boom 131 and the arm 132 closer to the target posture (step S9). At this time, the movement control unit 619 generates the automatic operation signal on the basis of the positions and speeds of the boom 131 and the arm 132 specified in step S7.

Also, the movement control unit 619 calculates a sum of angular velocities of the boom 131 and the arm 132 on the basis of the generated automatic operation signals for the boom 131 and the arm 132, and generates the automatic operation signal for rotating the clam bucket 133 at the same speed as the sum of the angular velocities (step S10). Thereby, the movement control unit 619 can generate the automatic operation signal for holding a ground angle of the clam bucket 133.

The movement control unit 619 determines whether or not the work equipment 130 is swinging (step S11). The movement control unit 619 determines that the swing body 120 is swinging when, for example, a swing speed is equal to or higher than a predetermined speed. If the work equipment 130 is not swinging (step S11: NO), the movement control unit 619 calculates a completion time until the work equipment 130 has the target posture on the basis of the speeds of the boom 131 and the arm 132 specified in step S7 (step S12). Also, the movement control unit 619 calculates a reaching time until the swing angle reaches the first interference avoidance angle θ₁ specified in step S5 when the swing body 120 starts swinging (step S13). The movement control unit 619 determines whether or not the completion time calculated in step S12 is less than the reaching time calculated in step S13 (step S14). That is, the movement control unit 619 determines whether or not the work equipment 130 has the target posture when the swing angle reaches the first interference avoidance angle θ₁.

If the completion time is equal to or more than the reaching time (step S14: NO), that is, when the work equipment 130 does not have the target posture before the swing angle reaches the first interference avoidance angle θ₁, the movement control unit 619 does not generate the swing operation signal for the swing body 120. On the other hand, if the completion time is less than the reaching time (step S14: YES), that is, when the work equipment 130 has the target posture before the swing angle reaches the first interference avoidance angle θ₁, the movement control unit 619 generates the swing operation signal for the swing body 120 (step S15). Thereby, the control device 160 can prevent the work equipment 130 from coming into contact with the loading target T.

Since the values of all the automatic operation flags recorded in the main memory 630 are ON, the output determination unit 621 determines that all the controlled objects are controlled by the automatic operation signals. Thereby, the operation signal output unit 622 outputs the automatic operation signal generated in at least one of steps S9, S10, and S15 to the control valve 123 (step S16). The loading machine 100 is thereby driven. Then, the control device 160 returns the processing to step S7 and continues the control.

On the other hand, if it is determined in step S11 that the work equipment 130 is swinging (step S11: YES), the movement control unit 619 determines whether or not the distal end of the arm 132 reaches the loading point due to inertial swing when the operation signal for the swing is stopped, on the basis of the swing speed of the work equipment 130 specified in step S7 (step S17). If the distal end of the arm 132 does not reach the loading point due to the inertial swing (step S17: NO), the movement control unit 619 generates the swing operation signal in step S15, and the operation signal output unit 622 outputs the swing operation signal to the control valve 123 in step S16.

On the other hand, if it is determined that the distal end of the arm 132 reaches the loading point due to the inertial swing (step S17: YES), the control device 160 updates the measurement data, the map data, and the posture of the work equipment 130 to the latest state by the state update processing shown in FIG. 8 (step S18 in FIG. 10). The movement control unit 619 determines whether or not the distal end of the arm 132 has reached the loading point on the basis of the map data updated in step S18 (step S19). If the distal end of the arm 132 has not reached the loading point (step S19: NO), the control device 160 returns the processing to step S18 and waits for the distal end of the arm 132 to reach the loading point. At this time, since the values of the automatic operation signals recorded in the main memory 630 are all ON, the control device 160 does not receive the manual operation of the operation device 143.

If the distal end of the arm 132 has reached the loading point (step S19: YES), the clam control unit 620 generates an opening operation signal for the clam bucket 133 (step S20). The operation signal output unit 622 outputs the opening operation signal generated in step S20 to the control valve 123 (step S21). The clam control unit 620 waits for the elapse of a certain period of time after outputting the opening operation signal for the clam bucket 133 (step S22). This time is a time required for a certain amount of earth to fall from the open clam bucket 133. Further, this time may be shorter than a time required for all the earth to fall from the clam bucket 133.

After a certain period of time, the target posture determination unit 618 determines the target posture of the work equipment 130 at the start of excavation by reading the predetermined target posture of the work equipment 130 at the start of excavation from the storage 650 or the main memory 630 (step S23). The target posture at the start of excavation is a posture such that, for example, the clam bucket 133 approaches the undercarriage 110 to the extent that it does not interfere with the undercarriage 110 and the bottom surface of the clam bucket 133 approaches a plane passing through the bottom surface of the undercarriage 110 to the extent that it does interfere with the plane.

Next, the control device 160 updates the measurement data, the map data, and the posture of the work equipment 130 to the latest state by the state update processing shown in FIG. 8 (step S24). Next, the movement control unit 619 determines whether or not the swing angle of the swing body 120 from the start of dumping to the present time is less than the second interference avoidance angle θ₂ which is a difference between the start angle θ₀ and the first interference avoidance angle θ₁ (step S25). If the swing angle is less than the second interference avoidance angle θ₂ (step S25: YES), since the work equipment 130 may come into contact with the loading target T, the movement control unit 619 generates the automatic operation signal (neutral signal) for maintaining the posture of the work equipment 130.

In step S25, if the swing angle is equal to or larger than the second interference avoidance angle θ₂ (step S25: NO), the movement control unit 619 determines whether or not the posture of the work equipment 130 specified in step S24 approximates the target posture determined in step S23 (step S26). If the posture of the work equipment 130 does not approximate the target posture (step S26: NO), the movement control unit 619 generates the automatic operation signal for bringing the boom 131, the arm 132, and the clam bucket 133 closer to the target posture (step S27). Also, the clam control unit 620 also generates a closing operation signal for the clam bucket (step S28). If the posture of the work equipment 130 approximates the target posture (step S26: YES), the movement control unit 619 does not generate the automatic operation signal for the work equipment 130.

Also, the movement control unit 619 determines whether or not the distal end of the arm 132 can swing to the start angle θ₀ specified in step S4 due to inertial swing when the operation signal for the swing has stopped, on the basis of the swing speed of the work equipment 130 specified in step S24 (step S29). If the distal end of the arm 132 cannot swing to the start angle θ₀ due to the inertial swing (step S29: NO), the movement control unit 619 generates a swing operation signal (step S30). On the other hand, if the distal end of the arm 132 can swing to the start angle θ₀ due to the inertial swing (step S29: YES), the movement control unit 619 does not generate the swing operation signal.

Next, as shown in FIG. 11, the output determination unit 621 selects the controlled object (the swing body 120, the boom 131, the arm 132, the clam bucket 133, or the clamshell 1332) one by one (step S31), and executes the processing from step S31 to step S42 for the selected controlled object.

The output determination unit 621 determines whether or not a value of the automatic operation flag related to the controlled object selected in step S31 is ON (step S32). If the value of the automatic operation flag is ON (step S32: YES), the output determination unit 621 determines whether or not the operation signal input unit 613 has received an input of the manual operation signal for operating the controlled object selected in step S31 (step S33). The output determination unit 621 determines that the input of the manual operation signal has been received when an operation amount of the manual operation signal is equal to or larger than a threshold value corresponding to an allowance.

Further, the manual operation signal related to the swing body 120 is an operation signal in the left-right direction by the left operation lever 143LO and an operation signal of the swing brake pedal 143TB. The manual operation signal related to the boom 131 is an operation signal in the front-rear direction by the right operation lever 143RO. The manual operation signal related to the arm 132 is an operation signal in the front-rear direction by the left operation lever 143LO. The manual operation signal related to rotation of the clam bucket 133 is an operation signal of the right operation lever 143RO in the left-right direction. The manual operation signals related to opening and closing of the clamshell 1332 are operation signals of the clam open pedal 143CO and the clam close pedal 143CC.

If there is an input of the manual operation signal related to the controlled object selected in step S31 (step S33: YES), the output determination unit 621 determines whether or not the manual operation signal indicates an operation resisting the automatic operation signal related to the controlled object generated in step S27, S28, or S30 (step S34). Specifically, if an operation direction of the manual operation signal is a direction opposite to an operation direction of the automatic operation signal, or if the operation of the manual operation signal is a brake operation, the output determination unit 621 determines that the manual operation signal indicates an operation resisting the automatic operation signal. For example, if the automatic operation signal indicates a counterclockwise swing operation and the manual operation signal indicates a clockwise swing operation, the output determination unit 621 determines that the manual operation signal indicates an operation resisting the automatic operation signal. Also, for example, if the automatic operation signal indicates a closing operation of the clamshell 1332 and the manual operation signal indicates an opening operation of the clamshell 1332, the output determination unit 621 determines that the manual operation signal indicates an operation resisting the automatic operation signal. Also, for example, if the automatic operation signal indicates a counterclockwise swing operation and the manual operation signal indicates depression of the swing brake pedal 143TB, the output determination unit 621 determines that the manual operation signal indicates an operation resisting the automatic operation signal.

If the manual operation signal is not an operation that resists the automatic operation signal (step S34: NO), the output determination unit 621 determines whether or not an operation amount of the manual operation signal is less than an operation amount of the automatic operation signal (step S35).

If the operation amount of the manual operation signal is less than the operation amount of the automatic operation signal (step S35: YES), or if it is determined in step S33 that there is no input of the manual operation signal (step S33: NO), the output determination unit 621 determines whether or not a control amount of the controlled object selected in step S31 has reached a target value (step S36). If the controlled object is the swing body 120, the output determination unit 621 determines whether or not the swing angle has reached the start angle θ₀. If the controlled object is the boom 131, the arm 132, or the clam bucket 133, the output determination unit 621 determines whether or not the rotation angle has reached an angle related to the target posture determined in step S23. If the controlled object is the clamshell 1332, the output determination unit 621 determines whether or not a degree of opening has reached zero.

When the control amount of the controlled object selected in step S31 has not reached the target value (step S36: NO), the output determination unit 621 determines that the controlled object selected in step S31 is controlled by the automatic operation signal. That is, the value of the automatic operation flag related to the controlled object selected in step S31 is maintained ON. The operation signal output unit 622 outputs the automatic operation signal related to the controlled object selected in step S31 among the automatic operation signals generated in steps S27, S28, and S30 (step S37).

On the other hand, if the manual operation signal is an operation that resists the automatic operation signal (step S34: YES), if an operation amount of the manual operation signal is not less than an operation amount of the automatic operation signal (step S35: NO), or if a control amount of the controlled object has reached the target value (step S36: YES), the output determination unit 621 performs the following processing. The output determination unit 621 determines whether or not the controlled object selected in step S31 is the link member (the boom 131, the arm 132, and the clam bucket 133) constituting the work equipment 130 (step S38).

If the controlled object that switches from the automatic operation to the manual operation is the link member constituting the work equipment 130 (step S38: YES), the output determination unit 621 determines whether or not the swing angle of the swing body 120 from the start of dumping to the present time is less than the second interference avoidance angle θ₂ which is a difference between the start angle θ₀ and the first interference avoidance angle θ₁ (step S39). If the swing angle is less than the second interference avoidance angle θ₂ (step S39: YES), there is a possibility that the work equipment 130 may come into contact with the loading target T, and therefore the output determination unit 621 determines that the controlled object selected in step S31 is controlled by the automatic operation signal. That is, the value of the automatic operation flag related to the controlled object selected in step S31 is maintained ON. Then, the operation signal output unit 622 outputs the automatic operation signal related to the controlled object selected in step S31 (step S37).

On the other hand, if the swing angle is equal to or larger than the second interference avoidance angle θ₂ (step S39: NO), the movement control unit 619 specifies, among the plurality of link members, a link member which is other than the link member selected in step S31 and whose automatic operation flag is ON. For example, if the boom 131 is selected in step S31, the movement control unit 619 specifies one whose automatic operation flag is ON among the arm 132 and the clam bucket 133. The movement control unit 619 reduces an operation amount of the automatic operation signal related to the specified link member at a certain rate from the operation amount determined in step S27 (step S40).

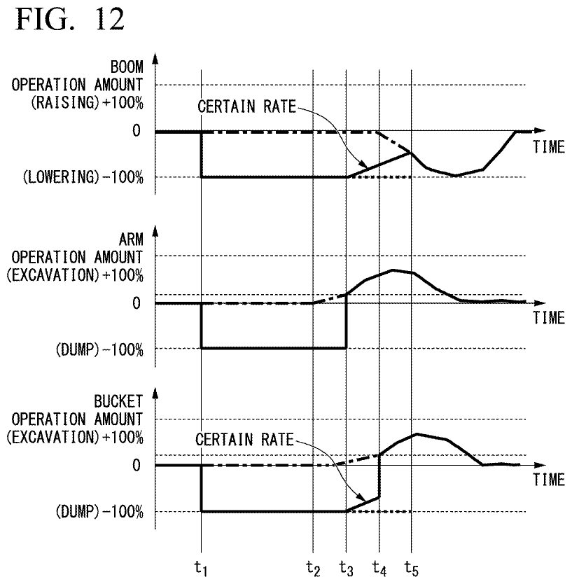

FIG. 12 is a diagram showing examples of operation signals for the work equipment according to the first embodiment. In FIG. 12, an operation amount of the output operation signal is indicated by a solid line, an operation amount of the automatic operation signal determined in step S27 is indicated by a dotted line, and an operation amount of the manual operation signal is indicated by a dashed-dotted line. In the example shown in FIG. 12, outputs of the automatic operation signals for the boom 131, the arm 132, and the clam bucket 133 start at time t₁. Thereafter, at time t₂, the operator starts inputting the manual operation signal for operating the arm 132 in a direction opposite to the automatic control. Also, following the arm 132, the operator also starts inputting the manual operation signal for operating the clam bucket 133 in a direction opposite to the automatic control. On the other hand, since operation amounts of both the arm 132 and the clam bucket 133 are less than a threshold value from time t₂ to time t₃, the output determination unit 621 determines in step S33 that no manual operation signal has been input. Therefore, the automatic operation signals are output as operation signals for the boom 131, the arm 132, and the clam bucket 133 from time t₁ to time t₃.

At time t₃, when the operation amount of the manual operation signal for the arm 132 becomes equal to or larger than the threshold value, since operation directions of the automatic operation signal and the manual operation signal are opposite to each other, the output determination unit 621 determines in step S34 that the manual operation signal is an operation resisting the automatic operation signal. Thereby, the automatic operation flag of the arm 132 is turned off, and thereafter, the manual operation signal is output as the operation signal for the arm 132. At this time, in step S40, the movement control unit 619 reduces operation amounts of the automatic operation signals for the boom 131 and the clam bucket 133 at a certain rate. That is, after time t₃, the operation amount of the output automatic operation signal (solid line in FIG. 12) reduces at a certain rate from the operation amount (dotted line in FIG. 12) determined in step S27.

Thereafter, at time t₄, when the operation amount of the manual operation signal for the clam bucket 133 is equal to or larger than the threshold value, since operation directions of the automatic operation signal and the manual operation signal are opposite to each other, the output determination unit 621 determines in step S34 that the manual operation signal is an operation resisting the automatic operation signal. Thereby, the automatic operation flag of the clam bucket 133 is turned off. Thereafter, the manual operation signals are output as the operation signals for the arm 132 and the clam bucket 133. Further, at time t₄, the operator starts inputting the manual operation signal for operating the boom 131 in the same direction as the automatic control. However, from time t₄ to time t₅, the operation amount is less than the operation amount of the automatic operation signal, and therefore the automatic operation signal is output as the operation signal for the boom 131.

Thereafter, at time t₅, when the operation amount of the manual operation signal for the boom 131 becomes equal to or larger than the operation amount of the automatic operation signal (step S35), the automatic operation flag of the boom 131 is turned off. Thereafter, the manual operation signal is output as the operation signal for the work equipment 130. In this way, in the example shown in FIG. 12, the movement control unit 619 switches the output signals to the manual operation signals in the order of the arm 132, the clam bucket 133, and the boom 131. Finally, operations of all the axes of the work equipment 130 are switched to manual operations.

Further, the processing shown in FIG. 12 is merely an example, and the order and timing of switching the automatic operation signals may differ according to an operation order of the operator.

That is, when only a part of the link members of the work equipment 130 are operated, the movement control unit 619 gradually brings operation amounts related to automatic operations of other link members closer to the output related to the manual operation. Thereby, the control device 160 can smoothly switch control of the work equipment 130 from the automatic operation to the manual operation.

Then, as shown in FIG. 11, the output determination unit 621 rewrites a value of the automatic operation flag related to the controlled object selected in step S31 to OFF (step S41). The output determination unit 621 thereby switches an output source of the operation signal from the automatic operation signal to the manual operation signal. Next, the movement control unit 619 outputs the manual operation signal related to the controlled object selected in step S31 (step S42).

When the automatic operation signal or the manual operation signal is output for each controlled object by the processing from step S31 to step S42, the output determination unit 621 determines whether or not all the values of the automatic operation flags recorded in the main memory 630 are OFF (step S43). That is, the output determination unit 621 determines whether or not all the controlled objects have been switched to the manual operation.

If a value of at least one automatic operation flag is ON (step S43: NO), the control device 160 returns the processing to step S24 in FIG. 10 to continue the automatic loading control. On the other hand, if values of all the automatic operation flags are OFF (step S43: YES), the control device 160 ends the automatic loading control.

### Operation and Effects

As described above, the control device 160 according to the first embodiment determines which of the manual operation signal and the automatic operation signal is to be output for each of the swing body 120 and the work equipment 130 on the basis of the manual operation signal input from the operation device 143. When the operator operates the operation device 143 during the automatic control of the loading machine 100, there is a possibility that the operator wishes to continue the automatic control for a controlled object to which an operation is not applied. Therefore, if all the controlled objects are switched to manual operations when there has been a manual operation by the operator, the operator may not recognize that all the operations have been switched to manual operations, and there is a possibility that the swing or the operation of the work equipment will stop, thereby lowering work efficiency. In contrast, according to the control device 160 of the first embodiment, the control device 160 determines which of the manual operation signal and the automatic operation signal is to be output for each of the swing body 120 and the work equipment 130, and therefore the automatic control can be continued for a controlled object to which the operation is not applied. Thereby, the control device 160 can prevent the work efficiency of the loading machine 100 from being lowered.

Also, according to the control device 160 of the first embodiment, when the manual operation signal is output for at least one link part among the plurality of link parts constituting the work equipment 130, an operation amount of the automatic operation signal for another link part is brought close to an operation amount of the manual operation signal at a certain rate. Thereby, the control device 160 can smoothly switch the control of the work equipment 130 from the automatic operation to the manual operation.

Also, the control device 160 according to the first embodiment outputs the automatic operation signal for any of the swing body 120 and the work equipment 130 in which an operation amount of the manual operation signal is less than an operation amount of the automatic operation signal. That is, the control device 160 does not switch to the manual operation signal for a controlled object whose operation amount of the manual operation signal is less than an operation amount of the automatic operation signal. Thereby, the control device 160 can prevent occurrence of sudden switching from the automatic operation signal to the manual operation signal.

Also, during the automatic control of moving the clam bucket 133 from above the loading target to an excavation point, the control device 160 according to the first embodiment outputs the automatic operation signal regardless of the manual operation signal until the swing angle of the swing body 120 reaches the interference avoidance angle. Thereby, even if there is an input of the manual operation of the work equipment 130 or the swing body 120 when the clam bucket 133 is positioned above the loading target, it is possible to prevent the work equipment 130 and the loading target from coming into contact with each other.

### Another Embodiment

The embodiments have been described above in detail with reference to the drawings; however, the specific configurations are not limited to the above-described configurations, and various design changes or the like can be made. That is, in another embodiment, the order of the above-described processing may be appropriately changed. In addition, some of the processing may be executed in parallel.

The control device 160 according to the above-described embodiment may be configured by a single computer, or may be configured such that the configurations of the control device 160 are divided and disposed in a plurality of computers and the plurality of computers cooperate with each other to function as the control device 160. At this time, a portion of the computers configuring the control device 160 may be mounted inside the loading machine 100 and the other computers may be provided outside the loading machine 100.

The loading machine 100 according to the above-described embodiment is a face excavator, but the present disclosure is not limited thereto. For example, the loading machine 100 according to another embodiment may be a backhoe. Further, if the loading machine 100 is a backhoe, a target posture of work equipment 130 at the start of excavation differs from that in the first embodiment. Since the backhoe performs excavation by pulling the work equipment 130 to the near side thereof, the position of the bucket in the target posture at the start of excavation is preferably away from the swing body 120. For example, the loading machine 100 may specify, as the target posture at the start of excavation, the shape of the object to be excavated from map data and determine a posture of the work equipment 130 which is moved away from the swing body 120 and come close to the object to be excavated and in which bucket teeth have an angle facing the object to be excavated.

The loading machine 100 according to the above-described embodiment has the clam bucket 133, but the present disclosure is not limited thereto. For example, the loading machine 100 according to another embodiment may include an ordinary bucket. In this case, the loading machine 100 has a dump control unit instead of the clam control unit 620. The dump control unit outputs a rotation operation signal in a dump direction instead of the opening operation signal. Further, in order to reduce a cycle time, the control device 160 may output a swing operation signal for the swing body 120 while the rotation operation signal in the dump direction is being output.

The target posture according to the above-described embodiment is set in advance and recorded in the main memory 630 or the storage 650, but the present disclosure is not limited thereto. For example, the loading machine 100 according to another embodiment may be configured such that the target posture can be changed by operating the operation terminal 142. For example, the loading machine 100 according to another embodiment may change the target posture by inputting numerical values representing positions and angles of the boom 131, the arm 132, and the a clam bucket 133 to the operation terminal 142. Also, in the loading machine 100 according to another embodiment, after controlling the work equipment 130 to a preferable posture by an operation of an operator, the work equipment position specifying unit 614 may specify a posture of the work equipment 130 by operating the operation terminal 142 and update the target posture with the above-described posture.

The control device 160 according to the above-described embodiment specifies the loading target on the basis of map data of the SLAM based on the measurement data of the detection device 156, but the present disclosure is not limited thereto. For example, the control device 160 according to another embodiment may receive an input of latitude, longitude, and an azimuth direction of the loading target and calculate a position and shape of the loading target in the vehicle body coordinate system from the measurement results of the position/azimuth direction calculator 151. Also, the control device 160 according to another embodiment may control the loading machine 100 on the basis of a global coordinate system represented by latitude, longitude, and an altitude instead of the vehicle body coordinate system. In this case, the control device 160 may calculate angles such as a start angle and a swing angle as angles relative to a reference azimuth direction of the global coordinate system.

The control device 160 according to the above-described embodiment calculates an angle of the swing body 120 by integrating the angular velocity of the swing body 120 measured by the inclination measuring device 152, but the present disclosure is not limited thereto. For example, the control device 160 according to another embodiment may calculate an angle of the swing body 120 on the basis of a difference in the azimuth direction measured by the position/azimuth direction calculator 151. Also, in another embodiment, the angle of the swing body 120 may be specified using a detection value of a rotation angle sensor provided in the swing motor 124.

The control device 160 according to the above-described embodiment performs the automatic loading control on the basis of a comparison between the swing angle and the interference avoidance angle, but the present disclosure is not limited thereto. For example, the control device 160 according to another embodiment may perform the automatic loading control on the basis of a comparison between the position of the clam bucket 133 and the rearmost point p1 (FIG. 5) of the outer shape of the loading target T in a swing direction of the swing body 120. For example, the control device 160 according to another embodiment may adjust a swing start timing so that the clam bucket 133 is positioned in a region in the vicinity of the point p1.

The loading machine 100 according to the above-described embodiment is directly operated by the operator who is on board the cab 140, but the present disclosure is not limited thereto. For example, the loading machine 100 according to another embodiment may be operated by a remote operation. That is, in another embodiment, an operation signal may be transmitted to the control device 160 by communication from the operation device 143 provided remotely. In this case, some or all of the configurations of the control device 160 may be provided in a remote operation room in which the operation device 143 is provided. For example, configurations of the operation signal input unit 613, the movement control unit 619, the output determination unit 621, the operation signal output unit 622, and the like may be included in a computer provided in the remote operation room.

The automatic loading control according to the above-described embodiment is configured such that the clam bucket 133 is moved from the position at the completion of excavation to the loading point and then is moved to the position for starting the subsequent excavation, but the present disclosure is not limited thereto. For example, in another embodiment, the clam bucket 133 may be moved from the position at the completion of excavation to the loading point and perform a dumping operation by a manual operation, and only movement of the loading machine 100 from the loading point to the position for starting the subsequent excavation may be automatically controlled. In this case, after the clam bucket 133 has reached the loading point, the operator may output a signal for driving the work equipment to the position for starting the subsequent excavation to the control device 160 by operating a switch provided in an operation lever or the like. The control device 160 controls the work equipment 130 according to the signal from the switch described above so that the posture of the work equipment 130 becomes a preset target posture different from that at the start of excavation as in the case of the automatic loading control according to the above-described embodiment.

The control device 160 according to the above-described embodiment controls the work equipment 130 on the basis of the position P of the distal end of the arm 132, but the position P of the distal end of the arm 132 may be a center of the distal end of the arm 132 or may be a position shifted to the left or right. Also, in another embodiment, the work equipment 130 may be controlled on the basis of an arbitrary position of the clam bucket 133 instead of the position P of the distal end of the arm 132.

### REFERENCE SIGNS LIST

100 Loading machine
110 Undercarriage (support part)
111 Endless track
120 Swing body
121 Engine
122 Hydraulic pump
123 Control valve
124 Swing motor
130 Work equipment
131 Boom
131C Boom cylinder
132 Arm
132C Arm cylinder
133 Clam bucket
1331 Backhaul
1332 Clamshell
1332C Clam cylinder
133C Bucket cylinder
140 Cab
141 Driver's seat
142 Operation terminal
143 Operation device
143SW Start switch
151 Position/azimuth direction calculator
152 Inclination measuring device
153 Boom angle sensor
154 Arm angle sensor
155 Bucket angle sensor
156 Detection device
160 Control device
610 Processor
611 Measurement data acquisition unit
612 Map generation unit
613 Operation signal input unit
614 Work equipment position specifying unit
615 Loading target specifying unit
616 Start angle specifying unit
617 Avoidance angle specifying unit
618 Target posture determination unit
619 Movement control unit
620 Clam control unit
621 Output determination unit
622 Operation signal output unit
630 Main memory
650 Storage
670 Interface

1. A control system for a loading machine including a swing body swinging around a swing center, a support part supporting the swing body, and work equipment having a bucket and attached to the swing body, the control system for a loading machine comprising:
an operation signal input unit configured to receive an input of a manual operation signal for the swing body and the work equipment on the basis of an operation of an operation device configured to operate the swing body and the work equipment;
a movement control unit configured to generate an automatic operation signal for driving the swing body and the work equipment;
an output determination unit configured to determine to output the manual operation signal for any of the swing body and the work equipment for which there has been an input of the manual operation signal and determine to output the automatic operation signal for any thereof for which there has been no input of the manual operation signal, on the basis of the input manual operation signal; and
an operation signal output unit configured to output the manual operation signal or the automatic operation signal for each of the swing body and the work equipment on the basis of a result of the determination.

2. The control system for a loading machine according to claim 1, wherein
the work equipment is provided with a plurality of link parts including the bucket, and
if the result of the determination indicates that the manual operation signal is output for at least one link part among the plurality of link parts, the movement control unit generates the automatic operation signal for another link part, which is other than the at least one link part, among the plurality of link parts such that an operation amount thereof approaches an operation amount of the manual operation signal related to the another link part.

3. The control system for a loading machine according to claim 1, wherein
the output determination unit determines to output the automatic operation signal for any of the swing body and the work equipment in which the operation amount of the manual operation signal is less than an operation amount of the automatic operation signal.

4. The control system for a loading machine according to claim 1, further comprising:
an avoidance angle specifying unit configured to specify an interference avoidance angle, which is a swing angle of the swing body at which the bucket and a loading target do not overlap in a plan view from above, during an automatic control of moving the bucket from above the loading target to an excavation start point, wherein
the operation signal output unit outputs the automatic operation signal for the work equipment regardless of the manual operation signal until the swing angle of the swing body reaches the interference avoidance angle.

5. A control method for a loading machine including a swing body swinging around a swing center, a support part supporting the swing body, and work equipment having a bucket and attached to the swing body, the control method for a loading machine comprising:
a step of receiving an input of a manual operation signal for the swing body and the work equipment on the basis of an operation of an operation device configured to operate the swing body and the work equipment;
a step of generating an automatic operation signal for driving the swing body and the work equipment;
a step of determining to output the manual operation signal for any of the swing body and the work equipment for which there has been an input of the manual operation signal and determining to output the automatic operation signal for any thereof for which there has been no input of the manual operation signal, on the basis of the input manual operation signal; and
a step of outputting the manual operation signal or the automatic operation signal for each of the swing body and the work equipment on the basis of a result of the determination.
